(19) United States
(12) Patent Application Publication
(10) Pub. No.: US 2024/0145122 A1
(43) Pub. Date: May 2, 2024

(54) INSULATED ELECTRIC WIRE AND WIRING HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Toru SHIMIZU, Yokkaichi-shi (JP); Toyoki FURUKAWA, Yokkaichi-shi (JP); Kyoma SAHASHI, Yokkaichi-shi (JP); Yoshitaka YAMADA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/281,092

(22) PCT Filed: Mar. 29, 2022
(86) PCT No.: PCT/JP2022/015370

§ 371 Date: Sep. 8, 2023

(30) Foreign Application Priority Data
Mar. 29, 2021 (JP) 2021-054540

(51) Int. Cl. H01B 7/08; H01B 7/00; H01B 7/04

(52) U.S. Cl. CPC H01B 7/08; H01B 7/0045; H01B 7/04; H01B 1/02

(57) ABSTRACT

An insulated electric wire containing a conductor having a flat shape and showing excellent selectivity for bending in the height direction of the flat shape, and a wiring harness containing such an insulated electric wire. An insulated electric wire contains a conductor and an insulation cover covering an outer periphery of the conductor. The conductor contains a flat portion which has a flat shape, in a cross section perpendicular to an axial direction of the conductor, having a larger size in a width direction than in a height direction. In the flat portion, a flexural rigidity in the width direction x of the insulated electric wire is 2.6 times or more than a flexural rigidity in the height direction y. The wiring harness contains the insulated electric wire.

### TECHNICAL FIELD

The present disclosure relates to an insulated electric wire and a wiring harness.

### BACKGROUND ART

A flat cable made of a flat-shaped conductor is commonly known. A flat cable occupies a smaller space for routing than a conventional electric wire containing a conductor having a substantially circular cross-section.

As disclosed in Patent Literatures 1 and 2, a flat rectangular conductor is often used as a conductor for conventional flat cable. The flat rectangular conductor is made of a single metal wire formed to have a rectangular cross-section. Further, Patent Literatures 3 and 4, which were applied by the applicants of the present invention, each disclose an electric wire conductor formed to contain a wire strand containing a plurality of elemental wires twisted together to have a flat shape, from the viewpoint of achieving both flexibility and a space-saving property.

### CITATION LIST

### Patent Literature

Patent Literature 1: JP 2014-130739 A
Patent Literature 2: JP 2019-149242 A
Patent Literature 3: WO 2019/093309 A1
Patent Literature 4: WO 2019/093310 A1

### SUMMARY OF INVENTION

### Technical Problem

When routing an electric wire containing a flat-shaped conductor in a predetermined space, such as inside an automobile, if the routing is carried out with the electric wire bent in the height direction (i.e., flat direction) of the flat shape, the bending will be easy and a load applied to the electric wire will be smaller. Moreover, the routing can be carried out by effectively using the space-saving property due to the flat shape. However, depending on the specific configuration of the electric wire, the electric wire bends not only in the height direction of the flat shape but also in the width direction (i.e., edge direction) in some cases. When an electric wire is designed and a routing path is set on the presumption that the routing will be carried out with the wire bent in the height direction of the flat shape, the bending of the wire in the width direction will become an obstacle to the routing work and cause difficulty in routing the wire in a predetermined route. If selective bending of the electric wire in the height direction can be achieved, the routing property of the electric wire improves.

Therefore, it is an object of the present invention to provide an insulated electric wire containing a conductor having a flat-shaped cross section and having an excellent selectivity for bending in the height direction of the flat shape, and a wiring harness containing such an insulated electric wire.

### Solution to Problem

The insulated electric wire of the present disclosure contains a conductor and an insulation cover covering an outer periphery of the conductor. The conductor contains a flat portion which has a flat shape, in a cross section perpendicular to an axial direction of the conductor, having a larger size in a width direction than in a height direction. The insulated electric wire has, in the flat portion, a higher flexural rigidity in the width direction 2.6 times or more than a flexural rigidity in the height direction.

The wiring harness of the present disclosure contains the insulated electric wire.

### Advantageous Effects of Invention

The insulated electric wire according to the present disclosure is an insulated electric wire containing a conductor having a flat-shaped cross section and having an excellent selectivity for bending in the height direction of the flat shape, and a wiring harness containing such an insulated electric wire.

### BRIEF DESCRIPTION OF DRAWINGS

FIG. 1 is a cross-sectional view illustrating an insulated electric wire according to one embodiment of the present disclosure.

FIG. 2 is a side view illustrating a measuring method of flexural rigidity.

FIG. 3 is a diagram indicating a relationship between a deflection and a bending load obtained by the measurement of flexural rigidity.

FIG. 4 is a side view illustrating a measuring method of bending stress.

### DESCRIPTION OF EMBODIMENTS

### Description of Embodiment of Present Disclosure

First, embodiments of the present disclosure will be described.

The insulated electric wire according to the present disclosure contains a conductor and an insulation cover covering an outer periphery of the conductor. The conductor contains a flat portion which has a flat shape, in a cross section perpendicular to an axial direction of the conductor, having a larger size in a width direction than in a height direction. The insulated electric wire has, in the flat portion, a higher flexural rigidity in the width direction 2.6 times or more than a flexural rigidity in the height direction.

The insulated electric wire has a flat portion having a higher flexural rigidity in the width direction 2.6 times or more than a flexural rigidity in the height direction. Thus, bending in the width direction is less likely to occur compared with bending in the height direction. That is, the selectivity of the insulated electric wire for bending in the height direction is enhanced. Therefore, when routing the insulated electric wire, the routing operation can be easily carried out by causing the bending in the height direction with avoiding unintended bending in the width direction.

Here, the conductor is preferably configured as a wire strand containing a plurality of elemental wires twisted together. This arrangement increases the bending flexibility of the conductor and facilitates, along with the bending of the flat shape in the height direction, the routing of the insulated electric wire. Compared with the case where the conductor is made of a single wire, flexibility in the width direction of the flat shape also increases. However, when the flexural rigidity in the width direction is 2.6 times or more than the flexural rigidity in the height direction, unintended bending of the insulated electric wire in the width direction can be sufficiently suppressed.

In this case, the conductor is, in the cross section of the conductor, preferably larger in the width direction 3.0 times or more than in the height direction. This arrangement increases the flatness of the flat shape of the conductor, and thus, in the insulated electric wire, a ratio of the flexural rigidity in the width direction to the flexural rigidity in the height direction can be effectively increased.

The elemental wires each preferably have an outer diameter of 0.32 mm or smaller. As the elemental wires constituting the wire strand are smaller, the flexibility of the conductor as a whole increases. Therefore, the insulated electric wire can bend smoothly in the height direction of the flat shape. On the other hand, due to the influence of the friction forces between the elemental wires, bendability in the width direction does not increase as much as that in the height direction. Thus, the selectivity of the insulated electric wire for bending in the height direction is enhanced effectively.

The conductor preferably has a conductor cross-sectional area of 100 mm² or larger. An insulated electric wire having a large conductor cross-sectional area may be difficult to be routed with the wire bent flexibly. However, the insulated electric wire according to the present disclosure can be easily routed using the selective bendability of the flat shape in the height direction.

The insulated electric wire preferably has a flexural rigidity of 0.5 N·m² or more in the width direction. With this arrangement, unintended bending of the insulated electric wire in the width direction can be suppressed effectively.

The insulated electric wire preferably has a flexural rigidity of less than 0.3 N·m² in the height direction. With this arrangement, the bending of the insulated electric wire in the height direction can be enhanced effectively.

The conductor is preferably made of aluminum or an aluminum alloy. Aluminum and aluminum alloys have lower conductivity than copper and copper alloys, and thus, the insulated electric wires made of aluminum or an aluminum alloy are usually designed to contain a conductor having a larger cross-sectional area. However, even when the cross-sectional area of the conductor is large, the insulated electric wire according to the present disclosure can be easily routed using the selective bendability of the flat shape in the height direction.

The wiring harness according to the present disclosure contains the insulated electric wire described above. By containing the insulated electric wire described above, the wiring harness shows excellent selectivity for bending in the height direction of the flat shape of the conductor. Thus, when routing the insulated electric wire in the form of the wiring harness in a predetermined space, the routing can be carried out easily with the wire bending in the height direction while reducing the influence of the bending of the wire in the width direction.

### DETAILS OF EMBODIMENTS OF PRESENT DISCLOSURE

Hereinafter, the insulated electric wire, and the wiring harness according to the embodiment of the present disclosure will be described in detail with reference to the drawings. In the present description, concerning the shapes of the respective parts of the insulated electric wire, concepts for describing the shapes or arrangements of the members, such as straight line, parallel, and vertical, may include deviations in the concepts of geometry within an allowable range for this type of insulated electric wires, such as a deviation of approximately plus or minus 15% in length, or a deviation of approximately plus or minus 150 in angle. In the present description, unless particularly noted, the cross section of the conductor or the insulated electric wire shall refer to a cross section cut perpendicular to an axial direction (i.e., the longitudinal direction). Respective properties are values evaluated at room temperature or in the atmosphere.

<Outline of Insulated Electric Wire>

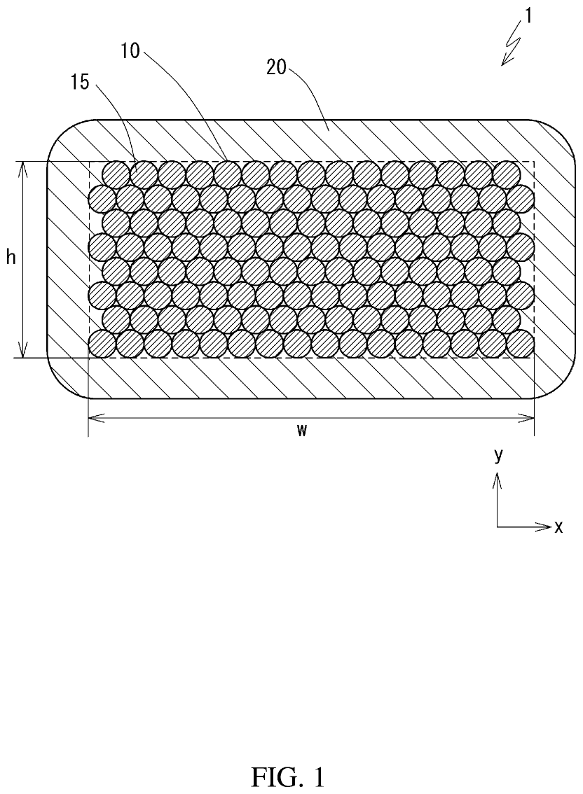

FIG. 1 shows a cross-sectional view of an insulated electric wire 1 according to an embodiment of the present disclosure. The insulated electric wire 1 according to the present embodiment contains a conductor 10 and an insulation cover 20. The insulation cover 20 covers an outer periphery of the conductor 10 across the entire circumference.

The conductor 10 may have a single wire structure made of an integrally formed metal material such as a metal foil or a metal plate, or be configured as a wire strand containing a plurality of elemental wires 15 twisted together. In the exemplified form in FIG. 1, the conductor 10 is configured as a wire strand.

The conductor 10 has a flat outer shape at least in a portion along the axial direction. That is, the conductor 10 has a flat portion which has a flat shape in a cross section perpendicular to the axial direction of the conductor 10. In the present embodiment, the conductor 10 is formed to have a flat portion in the entire axial direction. Here, the concept that the cross section of the conductor 10 has a flat shape indicates a state where a width w, which is the length of the longest line among lines that extend in the cross section in parallel to edges constituting the cross section and encompass the entire cross section, is larger than a height h, which is a length of the line perpendicular to the above-mentioned longest line and encompasses the entire cross section.

The cross section of the conductor 10 may have any specific shape as long as it is flat. In the present embodiment, the cross section of the conductor 10 is approximated as a rectangle. Here, the concept that the cross-sectional shape of the conductor 10 is rectangular indicates a state where the circumscribed shape of the conductor 10 indicated by the dashed lines in FIG. 1 can be approximated as a rectangle within a deviation range of approximately plus or minus 15° in terms of a mutual relationship between the respective edges. Examples of a flat shape other than a rectangular shape include an elliptical shape, an oval shape, a capsule shape (i.e., the shape of a rectangle with half circles in both ends), a parallelogram, and a trapezoidal shape.

When the conductor 10 is configured as a wire strand, the conductor 10 can be formed by, for example, rolling a raw wire strand containing the plurality of elemental wires 15 twisted together to form a substantially circular cross-sectional shape. To be formed into a flat shape, the cross sections of at least parts of the respective elemental wires 15 constituting the conductor 10 may be deformed from the circular shape. However, from the viewpoint of ensuring high flexibility of the conductor 10, deformation ratios from the circular shape of the elemental wires 15 are preferably lower in the outer peripheral portion than in the inner portion in the cross section of the conductor 10. Further, in the cross section of the conductor 10, vacancies capable of accommodating one or more, or even two or more of the elemental wires 15 are preferably left between the respective elemental wires 15.

The insulated electric wire 1 according to the present embodiment contains the conductor 10 having a flat-shaped cross section, and thus the wire 1 occupies a smaller space for routing than an electric wire containing a conductor having a substantially circular cross-section with the same conductor cross-sectional area. In other words, a space in which other electric wires or other members cannot be disposed around a certain electric wire can be made smaller. Especially, a space occupied by the electric wire along the height direction (y-direction) can be made smaller, and space-saving can be readily achieved. Furthermore, since the conductor 10 has a flat shape and is smaller in the height direction, the insulated electric wire 1 exhibits excellent flexibility in the height direction. Especially, when the conductor 10 is formed as a wire strand, it is configured as a collective body of the plurality of elemental wires 15 each having a small diameter, leading to excellent flexibility of the insulated electric wire 1. Thus, the insulated electric wire 1 according to the present embodiment can achieve both a high space-saving property and flexibility due to the conductor 10 having a flat shape.

The material constituting the conductor 10 is not particularly limited, and various metal materials can be applied. Examples of representative metal material constituting the conductor 10 include copper, copper alloys, aluminum, and aluminum alloys. In particular, since aluminum and aluminum alloys have lower conductivity than copper and copper alloys, the cross-sectional area of the conductor made of aluminum or aluminum alloys tends to be increased to secure necessary electric conduction. Therefore, the effect of flattening the conductor 10 for enhancing the space-saving property and the bending flexibility in the height direction increases. From this viewpoint, it is preferable that the conductor 10 is made of aluminum or an aluminum alloy. From the same viewpoint, the conductor 10 preferably has a cross-sectional area of 100 mm² or larger, or even 120 mm² or larger. While no specific upper limit is set for the cross-sectional area of the conductor 10, it is preferable to be 300 mm² or less, for example, from the viewpoint of securing bending flexibility.

A material constituting the insulation cover 20 is not particularly limited as long as it is an insulating material. Preferably, the material contains an organic polymer as a base material. Examples of the organic polymer include an olefin-based polymer, such as polyolefin and olefin-based copolymer, a halogen-based polymer, such as polyvinyl chloride, various elastomers, and rubbers. The organic polymer may be crosslinked or foamed. Furthermore, the insulation cover 20 may contain various additives, such as a flame retardant, in addition to the organic polymer.

Since the insulation cover 20 has much higher flexibility than the conductor 10, the flexibility of the entire insulated electric wire 1 is substantially defined by the flexibility of the conductor 10. Nevertheless, if the insulation cover 20 also has high flexibility, the flexibility of the entire insulated electric wire 1 can be increased more easily. From this viewpoint, the constituent material of the insulation cover 20 preferably has a flexural modulus of 30 MPa or less, or even 20 MPa or less.

The insulated electric wire 1 according to the present embodiment may be used alone or be used as a constituent member of the wiring harness according to the embodiment of the present disclosure. The wiring harness according to the embodiment of the present disclosure contains the insulated electric wire 1 according to the embodiment described above. The wiring harness may contain a plurality of the insulated electric wires 1 described above or may contain other types of insulated electric wires in addition to the insulated electric wire 1 described above. Preferably, a plurality of insulated electric wires 1 described above are arranged in an array(s) in the width direction (x-direction) and/or the height direction (y-direction). Here, the specific arrangement of the plurality of insulated electric wires 1 is not particularly limited. For example, as a preferable form, the plurality of insulated electric wires 1 are arranged in the width direction and fixed onto a common sheet material by fusing or other means. In this case, it is especially preferable that the plurality of insulated electric wires 1 are arranged to have the same height.

<Details of Configuration of Insulated Electric Wire>

Hereunder, details of the structure and properties of the insulated electric wire 1 will be described. In the following, descriptions will be made by mainly assuming that the conductor 10 is configured in the form of a wire strand made of aluminum or an aluminum alloy. However, as described above, in the insulated electric wire 1 according to the embodiment of the present disclosure, the conductor 10 may be in the form of a wire strand or a single wire, and the type of metal material constituting the conductor 10 is not particularly limited. The respective configurations described below can be applied regardless of the form or metal type of the conductor 10. Specific upper and lower limit values of respective parameters might vary depending on whether the conductor 10 is a wire strand or a single wire and depending on the metal type. However, the relation between the magnitude of the value of each parameter and the phenomenon that occur or the effect obtained does not depend on the form or metal type of the conductor 10.

In the insulated electric wire 1 according to the present embodiment, the conductor 10 has a flat shape, whereby the insulated wire 1 has a larger flexural rigidity in the width direction (edge direction; x-direction) than in the height direction (flat direction; y-direction). Especially, concerning the flexural rigidity of the insulated electric wire 1 in Formula (1) described below, a flexural rigidity ratio defined as a ratio of the flexural rigidity of the wire 1 in the width direction to the flexural rigidity of the wire 1 in the height direction is preferably 2.6 or more. That is, the wire 1 preferably has a higher flexural rigidity in the width direction 2.6 times or more than a flexural rigidity in the height direction.

[Flexural rigidity ratio]=[Flexural rigidity in the width direction]/[Flexural rigidity in the height direction] (1)

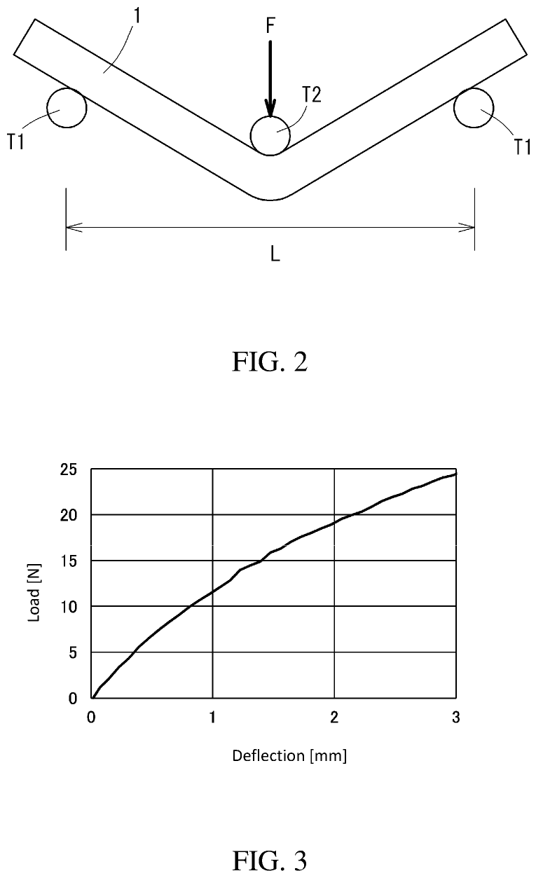

The flexural rigidity of the insulated electric wire 1 can be evaluated by, for example, the three-point bending test in conformity with JIS K 7171. Specifically, as illustrated in FIG. 2, the insulated electric wire 1 is supported by the two columns T1, T1 as fulcrums, and the column T2 is pushed in from a direction opposite to the supporting direction at a position in the middle of the columns T1, T1 to apply a bending load F to the insulated electric wire 1. Here, the pushed-in amount of the column T2 is the deflection of the insulated electric wire 1. Based on the measurement result, the flexural rigidity can be obtained by Formula (2) described below.

[Flexural rigidity]=([Bending load F]×[Distance between fulcrums L]³)/(48×[Deflection]) (2)

The three-point bending test described above is performed for the bending in the height direction and the bending in the width direction of the flat shape of the insulated electric wire 1. That is, a measurement is performed by directing the height direction of the insulated electric wire 1 into the load-applying direction, which is the longitudinal direction in FIG. 2, and also a measurement is performed by directing the width direction of the insulated electric wire 1 into the load-applying direction. Then, the flexural rigidity ratio can be obtained by the above Formula (1).

The insulated electric wire 1 has a higher flexural rigidity in the width direction 2.6 times or more than a flexural rigidity in the height direction, and thus the insulated electric wire 1 is flexibly bendable in the height direction, but not in the width direction. That is, the insulated electric wire 1 has excellent selectivity for bending in the height direction. Thus, when the insulated electric wire 1 is routed, the wire 1 can be routed through a predetermined route using its bending in the height direction while unintended bending in the width direction is suppressed. In the insulated electric wire 1, since the conductor 10 has a flat shape, the load applied to the conductor 10 and the insulation cover 20 by bending can be smaller when the wire 1 is bent in the height direction, which has a smaller length, than when the wire 1 is bent in the width direction, which has a larger length. Moreover, the insulated electric wire 1 has a high space-saving property in the height direction due to the flat shape of the conductor 10, and by routing the insulated electric wire 1 with it being bent in the height direction, the space-saving property can be effectively utilized in the wiring route. From the viewpoint of further enhancing these effects, the flexural rigidity ratio of the insulated electric wire 1 is preferably 3.0 or more, or even 3.5 or more. While no specific upper limit is set for the flexural rigidity ratio, the flexural rigidity ratio is preferably approximately 20.0 or less from the viewpoint of avoiding an excessive limitation to the bending in the width direction.

The flexural rigidity of the conductor 10 contributes significantly to the flexural rigidity of the entire insulated electric wire 1. Therefore, the flexural rigidity ratio of the insulated electric wire 1 can be adjusted by specific configurations of the conductor 10, such as the diameter of the elemental wire 15 constituting the wire strand or a flatness ratio of the conductor 10. As described later, the smaller the diameter of the elemental wire 15 is, and the larger the flatness ratio of the conductor 10 is, the more the flexural rigidity ratio of the wire 1 can be increased. The insulation cover 20 might have a slight influence on the flexural rigidities of the insulated electric wire 1 in the respective directions but the contribution is limited compared with the contribution of the conductor 10.

As long as the insulated electric wire has a flexural rigidity ratio of 2.6 or more, the magnitudes of the flexural rigidity in the height direction and the flexural rigidity in the width direction are not particularly limited. However, the larger the flexural rigidity in the width direction is, and the smaller the flexural rigidity in the height direction is, the easier it is to increase the flexural rigidity ratio and enhance the selectivity for bending in the height direction. For example, when the flexural rigidity in the width direction is 0.3 N·m² or more, or even 0.5 N·m² or more, or 0.8 N·m² or more, the bending of the insulated electric wire 1 in the width direction can be effectively suppressed. On the other hand, when the flexural rigidity in the height direction is less than 0.3 N·m² or even less than 0.25 N·m², the bending of the insulated electric wire 1 in the height direction can be effectively enhanced.

In the insulated electric wire 1, the flatness ratio of the conductor 10, which is the ratio of the width to the height (w/h) of the conductor 10 is preferably 2.0 or more. When the flatness ratio of the cross-sectional shape of the insulated electric wire 1 increases, a region occupied by the conductor 10 in the width direction increases compared with a region occupied by the height direction, making it harder for the conductor 10 to bend in the width direction. That is, the flexural rigidity ratio of the insulated electric wire 1 increases, and the selectivity for bending of the wire 1 in the height direction can be easily enhanced. It is especially preferable that the flatness ratio of the conductor 10 is 3.0 or more. While no specific upper limitation is set for the flatness ratio of the conductor 10, it is sufficient that the flatness ratio is 6.0 or less for example, from the viewpoint of avoiding excessive flattening.

When the conductor 10 is configured as a wire strand, an outer diameter of the elemental wire 15 constituting the wire strand is preferably 0.40 mm or smaller. When the conductor cross-sectional area is the same, the thinner the elemental wires 15 constituting the wire strand are, the higher the flexibility of the entire conductor 10 is. The effect of the enhanced flexibility of the conductor 10 due to the smaller diameter of the elemental wire 15 well reflects in the bending of the flat shape in the height direction, making the bending easier. On the other hand, in the width direction of the flat shape, the number of the elemental wires 15 arranged increases, and thus the sum of the friction forces acting between the elemental wires 15 when the bending is applied to the wires 15 increases. Accordingly, even if the elemental wires 15 are made smaller, the effect of the enhanced flexibility of the conductor 10 cannot be reflected much in the width direction. Therefore, by making the elemental wires 15 smaller, the flexibility of the flat shape in the height direction preferentially improves and the flexural rigidity ratio increases. The outer diameter of the elemental wire 15 is more preferably 0.32 mm or smaller, or even 0.30 mm or smaller. While no specific lower limit is set for the outer diameter of the elemental wire 15, it is preferably 0.1 mm or larger, for example, from the viewpoint of sustaining the strength of the elemental wire 15.

As described above, the larger the flexural rigidity ratio of the insulated electric wire 1 is, the more the selectivity of the wire 1 for bending in the height direction is enhanced. The selectivity of bending can be evaluated by, for example, flexural stress when the insulated electric wire 1 is bent. It can be said that the larger the bending stress of the insulated electric wire 1 is when the wire 1 is bent in the width direction compared with the bending stress of the insulated electric wire 1 when the wire 1 is bent in the height direction, the higher the selectivity of the wire 1 for bending in the height direction is. As described in an embodiment below, the insulated electric wire 1 is gripped at two positions that are 200 mm apart, and the wire 1 is bent up to 600 with a bending radius (r) of 150 mm. The flexural stress ratio is defined as the ratio of the stress generated at the gripping positions when the insulated electric wire 1 is bent in the width direction to the stress when the insulated electric wire 1 is bent in the height direction (Formula (3) below). When the flexural rigidity ratio is 2.6 or more, the flexural stress ratio is 4.0 or more.

[Flexural stress ratio]=[Flexural stress in the width direction]/[Flexural stress in the height direction] (3)

The flexural stress ratio of 4.0 or more means that the force required to bend the insulated electric wire 1 in the width direction is 4 times larger than the force required to bend the insulated electric wire 1 in the height direction. Therefore, when a force is applied to bend the insulated electric wire 1 in the height direction, unintentional bending of the insulated electric wire 1 in the width direction is quite less likely to occur. By setting parameters, such as the flatness ratio and the diameter of the elemental wire 15, in accordance with the specific form or metal type of the conductor 10 so as to achieve the flexural stress ratio of 4.0 or more, the selectivity of the insulated electric wire 1 for bending in the height direction can be sufficiently enhanced. It is even more preferable that the flexural stress ratio is 4.5 or more, or 5.0 or more.

### EXAMPLES

Hereinafter, examples are explained. It should be noted that the present invention is not limited to these examples. Here, the relationship between the flexural rigidity ratio and selectivity for bending in the height direction of an insulated electric wire containing a flat conductor was investigated. The preparation of samples and respective evaluations were performed at room temperature in the atmosphere.

(Preparation of Samples)

First, conductor of a wire strand was prepared by employing elemental wires of an aluminum alloy. The conductor structures and the outer diameters of the elemental wires used in Samples A1 to A8 were as indicated in Table 1. The conductor structures are each described in the order of “number of parent wire strand/number of child wire strand/elemental wire diameter (mm).” The conductors were prepared by rolling the obtained wire strands into a flat shape using a roller. Here, by changing the rolling rate, the flatness ratio w/h was obtained as listed in Table 1. Additionally, as Samples B1 to B5, conductors each having a single wire structure were also prepared by employing an aluminum alloy.

In the outer peripheries of the prepared respective conductors, an insulation cover having a thickness of 1.6 mm was formed by extrusion molding. As the covering materials, the following two types were used.
Covering material 1—Organic polymer: silane-crosslinked polyethylene (100 mass parts), Additive: magnesium hydroxide (70 mass parts), Flexural modulus: 35 MPa
Covering material 2—Organic polymer: silane-crosslinked polyethylene (100 mass parts), Additive: bromide-based flame retardant (30 mass parts) and antimony trioxide (10 mass parts), Flexural modulus: 15 MPa

(Evaluation of Flexural rigidity)

For the obtained respective insulated electric wires, bending rigidities in the width direction and the height direction were measured by the three-point bending test in conformity with JIS K 7171. Specifically, as illustrated in FIG. 2, the insulated electric wire 1 was supported by the two columns T1, T1 as fulcrums, and the column T2 was pushed in from a direction opposite to the supporting direction at a position in the middle of the columns T1, T1 to apply a bending load F to the insulated electric wire 1. The relation between the bending load F and the deflection of the insulated electric wire 1 as the push-in amount of the column T2 was recorded. The distance between the fulcrums L was 100 mm, and the length of the insulated electric wire 1 used as a sample was 150 mm. The columns T1, T2 used for supporting the insulated electric wire 1 and applying the bending load had a diameter of 5 mm. The speed of the push-in when applying the bending load F was 100 mm/minute.

The measurement was performed for bending in the height direction of the flat shape and bending in the width direction of the flat shape, respectively. According to the measurement, as exemplified in FIG. 3, the relation between the deflection and the bending load can be obtained. By using the values of the deflection and the bending load in a region where the deflection is small, the flexural rigidities in the respective directions were calculated by the above-described Formula (2). Subsequently, using the obtained values, the flexural rigidity ratio, which is a ratio of the flexural rigidity in the width direction to the flexural rigidity in the height direction as in Formula (1), was obtained. FIG. 3 shows a measurement result where bending in the width direction was applied to Sample A1 in Table 1.

(Evaluation of Flexural stress)

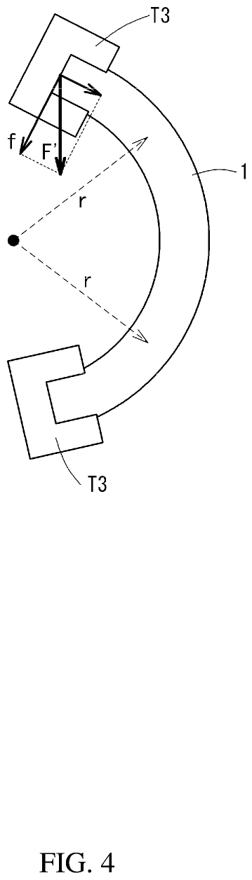

For the obtained insulated electric wires each containing a conductor of a wire strand, the flexural stress was measured by a method illustrated in FIG. 4. In the measurement, each of the insulated electric wires 1 was cut out in a length of 200 mm, the both ends of the wire 1 were gripped by gripping tools T3, T3 respectively, and bending was applied to the insulated electric wires 1. With the insulated electric wire 1 bent with a predetermined bending radius, the load F′ applied to the end portion of the insulated electric wire 1 was measured by load cells attached to the gripping tool. The load F′ that is applied perpendicularly to the axial direction of the insulated electric wire 1 was obtained and defined as a flexural stress f. Three types of bending radius (r), 150 mm, 100 mm, and 50 mm, were used. The measurement of the flexural stress was performed for bending in the height direction and bending in the width direction of the flat shape. Then, the flexural stress ratio, which is the ratio of the flexural stress in the width direction to the flexural stress in the height direction as in Formula (3), was obtained.

(Results)

Table 1 shows the structures of the insulated electric wires and the respective evaluation results of Samples A1 to A8 each containing a conductor of a wire strand.

TABLE 1

| Sample Number | | A1 | A2 | A3 | A4 |
|---|---|---|---|---|---|
| Elemental Wire | | 0.32 | 0.26 | 0.32 | 0.26 |
| Diameter [mm] | | | | | |
| Conductor Structure | | 19/86/0.32 | 19/130/0.26 | 19/86/0.32 | 19/130/0.26 |
| Cross-Sectional Area of | | 130 | 130 | 130 | 130 |
| Conductor [mm²] | | | | | |
| Flatness Ratio of | | 3.0 | 3.0 | 3.0 | 3.0 |
| Conductor (w/h) | | | | | |
| Type of Covering Material | | Covering Material 1 | Covering Material 1 | Covering Material 2 | Covering Material 2 |
| Elastic Modulus of | | 35 | 35 | 15 | 15 |
| Covering Material [MPa] | | | | | |
| Conductor | Width | 25.0 | 25.0 | 25.0 | 25.0 |
| Size [mm] | Height | 8.3 | 8.3 | 8.3 | 8.3 |
| Electric Wire | Width | 28.2 | 28.2 | 28.2 | 28.2 |
| Size [mm] | Height | 11.5 | 11.5 | 11.5 | 11.5 |
| Flexural | Width Direction | 0.26 | 0.22 | 0.22 | 0.13 |
| Rigidity | Height Direction | 0.8 | 0.91 | 0.69 | 0.34 |
| [N · m²] | | | | | |
| Flexural Rigidity Ratio | | 3.1 | 4.1 | 3.1 | 3.3 |
| Flexural | r = 150 mm | 44 | 40 | 30 | 27 |
| stress Width | r = 100 mm | 54 | 48 | 39 | 33 |
| Direction [N] | r = 50 mm | 61 | 52 | 45 | 43 |
| Flexural | r = 150 mm | 6 | 5 | 5 | 4 |
| stress Height | r = 100 mm | 10 | 9 | 8 | 6 |
| Direction [N] | r = 50 mm | 19 | 19 | 18 | 14 |
| Flexural | r = 150 mm | 7.3 | 8.0 | 6.0 | 6.8 |
| stress | r = 100 mm | 5.4 | 5.3 | 4.9 | 5.5 |
| Ratio | r = 50 mm | 3.2 | 2.7 | 2.5 | 3.1 |
| Sample Number | | A5 | A6 | A7 | A8 |
| Elemental Wire | | 0.32 | 0.42 | 0.32 | 0.32 |
| Diameter [mm] | | | | | |
| Conductor Structure | | 19/86/0.32 | 19/49/0.42 | 19/86/0.32 | 19/86/0.32 |
| Cross-Sectional Area of | | 130 | 130 | 130 | 130 |
| Conductor [mm²] | | | | | |
| Flatness Ratio of | | 4.0 | 3.0 | 2.0 | 2.5 |
| Conductor (w/h) | | | | | |
| Type of Covering Material | | Covering Material 1 | Covering Material 1 | Covering Material 1 | Covering Material 1 |
| Elastic Modulus of | | 35 | 35 | 35 | 35 |
| Covering Material [MPa] | | | | | |
| Conductor | Width | 28.5 | 25.0 | 20.8 | 23.0 |
| Size [mm] | Height | 7.1 | 8.3 | 10.4 | 9.2 |
| Electric Wire | Width | 31.7 | 28.2 | 24.0 | 26.2 |
| Size [mm] | Height | 10.3 | 11.5 | 13.6 | 12.4 |
| Flexural | Width Direction | 0.2 | 0.33 | 0.37 | 0.31 |
| Rigidity | Height Direction | 1.07 | 0.87 | 0.48 | 0.67 |
| [N · m²] | | | | | |
| Flexural Rigidity Ratio | | 5.4 | 2.6 | 1.4 | 2.1 |
| Flexural | r = 150 mm | 44 | 47 | 27 | 28 |
| stress Width | r = 100 mm | 54 | 55 | 31 | 37 |
| Direction [N] | r = 50 mm | 61 | 60 | 38 | 44 |
| Flexural | r = 150 mm | 4 | 10 | 11 | 8 |
| stress Height | r = 100 mm | 8 | 15 | 17 | 14 |
| Direction [N] | r = 50 mm | 17 | 23 | 20 | 20 |
| Flexural | r = 150 mm | 11 | 4.7 | 2.5 | 3.5 |
| stress | r = 100 mm | 6.8 | 3.7 | 1.8 | 2.6 |
| Ratio | r = 50 mm | 3.6 | 2.6 | 1.9 | 2.2 |

In Table 1, the flexural rigidity ratios and the flexural stress ratios with r=150 mm of the insulated electric wires are indicated in boldface. When comparing these values, the more the flexural rigidity ratio increases, the more the flexural stress ratio with r=150 mm increases substantially. That is, it can be understood that the more the flexural rigidity ratio increases, the more the selectivity of the flat shape for bending in the height direction is enhanced. Further, as for Samples A1 to A6 each having a flexural rigidity ratio of 2.6 or more, the flexural stress ratio is 4.0 or more. That is, the force necessary to bend the insulated electric wire in the width direction is 4.0 times or more than the force necessary to bend the insulated electric wire in the height direction, achieving significantly high selectivity for bending in the height direction. On the other hand, as for Samples A7, A8, the flexural rigidity ratio is less than 2.6 and the flexural stress ratio is less than 4.0, showing low selectivity for bending in the height direction. From these results, it can be understood that, for an insulated electric wire containing a flat-shaped conductor, the flexural rigidity ratio is a good indicator of selectivity in the bending direction. When the flexural rigidity ratio is 2.6 or more, an insulated electric wire achieves high selectivity for bending in the height direction.

Samples A1, A5, A7, and A8 are different from each other concerning the flatness ratio of the conductor. The flatness ratios are higher in the order of Sample A5, Sample A1, Sample A8, and Sample A7. The flexural rigidity ratios are higher in the order of Sample A5, Sample A1, Sample A8, and Sample A7, and the magnitude relation coincides with that of the flatness ratio. From these results, it can be understood that, by increasing the flatness ratio of the conductor, the flexural rigidity ratio of the insulation cover can be increased, whereby the selectivity for bending in the height direction can be enhanced.

Samples A1, A2, and A6 are different from each other concerning the elemental wire diameter. The elemental wire diameters are larger in the order of Sample A6, Sample A1, and Sample A2. On the other hand, the flexural rigidity ratios are higher in the order of Sample A2, Sample A1, and Sample A6, and the magnitude relation is opposite to that of the elemental wire diameter. From these results, it can be understood that, by reducing the outer diameter of the elemental wires constituting the conductor, the flexural rigidity ratio of the insulation cover can be increased, whereby the selectivity for bending in the height direction can be enhanced.

The pairs of Samples A1, A3 and Samples A2, A4 differ in the types of covering materials, respectively. In both pairs, the values of the bending rigidities in the width direction and the height direction are both larger when using the covering material 1 having a high elastic modulus (Samples A1 and A2) than when using the covering material 2 having a low elastic modulus (Samples A3 and A4). Meanwhile, the difference of the flexural rigidity ratio due to the difference in the type of covering material is small. Especially, in the pair of Samples A1, A3, the values of the flexural rigidity ratio are the same regardless of the type of covering material. Accordingly, it can be said that concerning the flexural rigidity ratio of the insulated electric wire, the effect of the type of insulation cover is limited, and the influence of the structure of the conductor is dominant.

As described above, the flexural stress ratio with the large bending radius of r=150 mm exhibits a good correlation with the flexural rigidity ratio and shows a tendency that the more the flexural rigidity ratio increases, the more the flexural stress ratio increases. Even in the cases of r=100 mm and r=50 mm, a roughly similar tendency, which is the more the flexural rigidity ratio increases, the more the flexural stress ratio increases can be recognized, but the correlation between the flexural rigidity ratio and the flexural stress ratio is lower than in the case of r=150 mm. For example, comparing Sample A1 and Sample A2, the flexural rigidity ratio is larger in Sample A2, and the flexural stress ratio with r=150 mm is also larger in Sample A2. However, the flexural stress ratios with r=100 mm and r=50 mm are larger in Sample A1 and the relationship has been reversed. It can be understood that when the bending radius is small, a large force is necessary for the bending in the width direction, and a large force is also necessary for some degrees for the bending in the height direction. Therefore, even where the flexural rigidity ratio is large, that is, even where a large difference exists between the flexural rigidity in the width direction and the flexural rigidity in the height direction, differences in the force necessary for bending, which are differences in the flexural stress, are small irrespective of the bending directions. In the routing of the insulated electric wire, unintended bending in the width direction is likely to occur when the bending is carried out with a large bending radius large, in which the force necessary for bending is small. As described above, the flexural rigidity ratio of the insulated electric wire exhibits a high correlation with the flexural stress ratio with a large bending radius, such as r=150 mm. Accordingly, it can be said that the flexural rigidity ratio will be used as a good indicator to avoid an unintended bending in the width direction especially when a gentle bending with a large bending radius is carried out.

Lastly, Table 2 shows the structures of the electric wires and evaluation results of the flexural rigidity for Samples B1 to B5 each containing a conductor formed as a single wire structure.

TABLE 2

| Sample Number | B1 | B2 | B3 | B4 | B5 |
|---|---|---|---|---|---|
| Cross-Sectional Area of | 130 | 130 | 130 | 130 | 130 |
| Conductor [mm²] | | | | | |
| Flatness Ratio of | 1.0 | 2.0 | 3.0 | 4.0 | 5.0 |
| Conductor (w/h) | (Round Rod) | | | | |
| Type of Covering Material | Covering Material 1 | Covering Maetrial 1 | Covering Material 1 | Covering Material 1 | Covering Material 1 |
| Elastic Modulus of | 35 | 35 | 35 | 35 | 35 |
| Covering Material | | | | | |
| [MPa] | | | | | |
| Conductor Size [mm] | | | | | |
| Width | 12.9 | 17.1 | 20.5 | 23.4 | 26.1 |
| Height | 12.9 | 8.5 | 6.8 | 5.9 | 5.2 |
| Electric Wire Size [mm] | | | | | |
| Width | 16.1 | 20.3 | 23.7 | 26.6 | 29.3 |
| Height | 16.1 | 11.7 | 10 | 9.1 | 8.4 |
| Flexural Rigidity [N · m²] | | | | | |
| Width Direction | 96 | 49 | 31 | 25 | 20 |
| Height Direction | 96 | 185 | 280 | 379 | 478 |
| Flexural Rigidity Ratio | 1.0 | 3.8 | 9.0 | 15.2 | 23.9 |

According to Table 2, even where the conductor is formed as a single wire structure, by making the conductor into a flat shape as with Samples B2 to B5, the flexural rigidity ratio is 2.6 or more as in the case where the conductor is configured as a wire strand. Furthermore, when the flatness ratio has increased in the order from Samples B2 to B5, the flexural rigidity ratio has also increased accordingly.

Although embodiments of the present disclosure have been described above in detail, the present invention is not limited to the embodiments described above, and various changes and modifications can be made without deviating from the scope of the present invention.

### LIST OF REFERENCE SIGNS

1: insulated electric wire
10: conductor
15: elemental wire
F: bending load in the evaluation of flexural modulus
F′: load measured in the evaluation of flexural stress
f: flexural stress
L: distance between fulcrums
r: bending radius
T1, T2: column
T3: gripping tool
x: width direction
y: height direction

1. An insulated electric wire comprising:
a conductor; and
an insulation cover covering an outer periphery of the conductor, wherein
the conductor comprises a flat portion which has a flat shape, in a cross section perpendicular to an axial direction of the conductor, having a larger size in a width direction than in a height direction,
the insulated electric wire has, in the flat portion, a higher flexural rigidity in the width direction 3.0 times or more than a flexural rigidity in the height direction, and
the conductor is configured as a wire strand comprising a plurality of elemental wires twisted together each having an outer diameter of 0.30 mm or smaller.

2. The insulated electric wire according to claim 1, wherein the conductor has a cross-sectional area of 100 mm² or larger.

3. The insulated electric wire according to claim 1, wherein the conductor is, in the cross section of the conductor, larger in the width direction 3.0 times or more than in the height direction.

4. The insulated electric wire according to claim 1, wherein the insulated electric wire has a flexural rigidity of 0.5 N·m² or more in the width direction.

5. The insulated electric wire according to claim 1, wherein the insulated electric wire has a flexural rigidity of less than 0.3 N·m² in the height direction.

6. The insulated electric wire according to claim 1, wherein the conductor is made of aluminum or an aluminum alloy.

7. A wiring harness, comprising the insulated electric wire according to claim 1.

8-10. (canceled)
